(19) United States
(12) Patent Application Publication
(10) Pub. No.: US 2024/0056166 A1
(43) Pub. Date: Feb. 15, 2024

(54) TRANSMISSION OF COVERAGE INDICATOR BY REMOTE USER EQUIPMENT (UE) DEVICES

(71) Applicant: Kyocera Corporation, Kyoto (JP)

(72) Inventors: Henry CHANG, San Diego, CA (US); Masato FUJISHIRO, Yokohama (JP)

(21) Appl. No.: 18/271,019

(22) PCT Filed: Jan. 13, 2022
(86) PCT No.: PCT/US2022/012286

§ 371 Date: Jul. 5, 2023

Related U.S. Application Data
(60) Provisional application No. 63/137,336, filed on Jan. 14, 2021.

(51) Int. Cl. H04B 7/155; H04W 40/24; H04W 40/22

(52) U.S. Cl. CPC H04B 7/15542; H04W 40/24; H04W 40/22; H04W 88/04

(57) ABSTRACT

A remote user equipment (UE) device transmits a coverage indicator to a relay UE device served by a first cell where the coverage indicator at least indicates that the remote UE device is in coverage of a second cell. The coverage indicator may include other information such as a frequency used by the second cell, a cell identifier of the second cell, bandwidth combination capability of the remote UE device, and/or a sidelink (SL) discovery pool of the second cell. The relay UE device forwards information based on the coverage indicator to the first cell. For L2 relaying, the first cell provides discovery resource information that is forwarded by the relay UE device to the remote UE device allowing the remote UE device to transmit discovery messages that can be received by the relay UE device with minimal or no interference in the second cell.

### CLAIM OF PRIORITY

The present application claims the benefit of priority to Provisional Application No. 63/137,336 entitled “Discovery Resource for Relaying”, docket number TPRO 00355 US, filed Jan. 14, 2021, assigned to the assignee hereof and hereby expressly incorporated by reference in its entirety.

### FIELD

This invention generally relates to wireless communications and more particularly to resource management of wireless communication links using relay devices.

### BACKGROUND

Many wireless communication systems that employ several base stations that provide wireless service to user equipment (UE) devices enable sidelink communication between two or more UE devices where the UE devices can communicate directly with other UE devices. With sidelink communication, UE devices transmit data signals to each other over a communication link using the cellular resources instead of through a base station. Such Proximity Services (ProSe) communication is sometimes also referred to as device-to-device (D2D). In addition, one or more UE devices can be used as relay devices between a UE device and a destination where the relay device forwards data between a UE device and the destination. The destination may be a communication network or another UE device (destination UE device). Where the destination is the network, the relay functionality is typically referred to as UE-to-Network (U2N) relaying and the relay UE device establishes a communication path between the remote UE and a base station (gNB) or cell. In some situations, for example, the UE device may be out of the service area of the base station and the relay UE device provides a communication link routed from such an out-of-coverage (OoC) UE device through a relay UE device to the base station. Where the destination device another UE device (target UE device), the relaying functionality is typically referred to as UE-to-UE (U2U) relaying.

### SUMMARY

A remote user equipment (UE) device transmits a coverage indicator to a relay UE device served by a first cell where the coverage indicator at least indicates that the remote UE device is in coverage of a second cell. The coverage indicator may include other information such as a frequency used by the second cell, a cell identifier of the second cell, and/or a sidelink (SL) discovery pool of the second cell. In some situations, the bandwidth combination capability of the remote UE device may also be included. The relay UE device forwards information based on the coverage indicator to the first cell. For L2 relaying, the first cell provides discovery resource information that is forwarded by the relay UE device to the remote UE device allowing the remote UE device to transmit discovery messages that can be received by the relay UE device with minimal or no interference in the second cell. With L3 relaying, the relay UE device is granted resources for transmission of SL data signals that can be received by the remote UE device.

### BRIEF DESCRIPTION OF THE DRAWINGS

FIG. 1A is a block diagram of communication system for an example where a remote UE device transmits a cell coverage indicator to a serving base station 106 through via relay UE device.

FIG. 1B is a block diagram of the system for an example where the relay UE device 108 sends discovery resource information to the remote UE device.

FIG. 1C is a block diagram of the system for an example where the remote UE device sends a SL discovery message using discovery transmission resources that will not interfere with communication in the second cell.

FIG. 2A is a block diagram of the communication system for an example where a remote UE device transmits a cell coverage indicator to a serving base station via relay UE device providing L3 relaying.

FIG. 2B is a block diagram of the system for an example where the first gNB 106 sends discovery resource information to the relay UE device providing L3 relaying for the remote UE device.

FIG. 2C is a block diagram of the system for an example where the remote UE device transmits a SL discovery message using SL discovery resources of the second cell and the SL discovery message is received by the relay UE device that can provide L3 relaying for the remote UE device.

FIG. 3 is a block diagram of an example of a coverage indicator.

FIG. 4 is a block diagram of an example of a base station suitable for use as both the base stations and any base station serving any of the UE devices.

FIG. 5 is a block diagram of an example of a UE device suitable for use as each of the UE devices.

FIG. 6 is a flow chart of an example of a method of sending a coverage indicator from remote UE device.

FIG. 7 is a flow chart of an example of a method of sending a coverage indicator from a remote UE device where a relay UE device is providing L3 relaying to a first cell.

FIG. 8 is a flow chart of an example of a method of managing discovery resources after receiving a coverage indicator from remote UE device.

FIG. 9 is a flow chart of an example of a method of managing discovery resources after receiving a coverage indicator from remote UE device when providing L3 layering service.

### DETAILED DESCRIPTION

As discussed above, a relay UE device provides connectivity between a remote UE device and a destination which can be another UE device (destination UE device) or a network. Where the destination is the network, the relay provides connectivity to a cell provided by a base station (gNB) of the network. The relayed connection between a remote UE device and destination UE device is sometimes referred to as a UE to UE (U2U) relay connection. The relayed connection between a remote UE device and a base station (gNB) is sometimes referred to as a UE to network (U2N) relay connection. In conventional systems where the relay connects to a base station (gNB), the relay UE device is required to meet certain criteria to function as a relay. For example, the relay UE device must be in coverage and have a cellular (Uu) communication link to the base station of sufficient quality in order to be available for relaying functions. For U2N relaying, therefore all candidate relay devices are assumed to be within coverage of the base station (gNB).

With U2U relaying, typically there is no such restriction and the relay UE device may be in coverage or OoC of the cell. The working principle of the two relaying mechanisms are different. Currently, in order for a remote UE device and the relay UE device to discover each other as part of the relay selection and reselection procedure, Model A or Model B discovery procedure is used. With Model A discovery, either the remote UE or the relay UE may announce their presence with “I am here” and no response is expected. With Model B discovery, a request is made by announcing “Are you there?” The receiving device may respond to the request of its presence. One of the important factors in the discovery procedure is the determination of the resource used by the discovery announcements. In general, if the D2D device is in coverage of a cell, the discovery resource should be controlled by the gNB and if the D2D device is OoC the D2D device may use the pre-configured discovery resource. In conventional systems, however, there are some cases when it is not clear whether the D2D device should use the network configured discovery resources or the pre-configured discovery resource.

Conventional systems support the following two scenarios for Layer 2 (L2) U2N relay procedures: 1) the relay UE device and remote UE device are in the same cell before remote connection via the relay UE device, and 2) before remote connection via a relay UE device, the relay UE device and the remote UE device are in different cells. Regarding discovery in conventional systems, a remote UE device in Radio Resource Control (RRC) states of RRC_CONNECTED, RRC_IDLE and RRC_INACTIVE is allowed to transmit discovery messages if the measured signal strength of the serving cell is lower than a configured threshold.

Based on the above conventions, there is no established criteria or procedure for determining the discovery resources to be used when the relay UE device is in a first cell and the remote UE is in coverage of a second cell. For example, the remote UE device should not use pre-configured resources for discovery announcements since the remote UE device is in coverage of the second cell. Although, the remote UE device is physically within coverage of the second cell and is connected to gNB via the relay UE device in the first cell, the conventional systems dictate that the remote UE device use discovery resources of the first cell for L2 relaying. In some situations when the remote UE device is near the edge of the second cell, it may begin to search for relay UE devices by sending discovery announcements. In some case, the relay UE device may be the better connection over sidelink or PC5 link than the direct connection to the gNB over the Uu link.

When the remote UE device is connected to the first cell via the L2 relay UE device, the discovery configuration should be controlled by first cell even though the remote UE device is physically located within the coverage of second cell. In many situations, the first cell and the second cell may be operating in the same frequency, so the discovery resources provided to the UE devices in the first cell, including the relay UE device, may interfere with communications in the second cell. As a result, it is advantageous for the first cell gNB to have information regarding the discovery resources of the second cell when the first cell gNB is providing discovery resource to the remote UE via the relay UE such that these allocated discovery resources do not interfere with operations in the second cell.

For the examples herein, the remote UE device informs its serving cell (first cell) via the relay UE device that the remote UE device is within coverage of another cell (second cell). This information, such as a coverage cell indicator, may be sent to the relay UE device via a PC5-RRC message or PC5 broadcast message. In turn, the relay UE device informs its serving cell (first cell) that the remote UE device is in coverage of the second cell. In some situations, the information prompts the first cell gNB to coordinate with the second cell gNB over the Xn interface for the use of discovery resources in the same frequency. In case the remote UE device is disconnected (over PC5) with the relay UE device, either due to PC5-RLF, Uu RLF or if the SL-RSRP measurements falls below a configured threshold, the remote UE device may need to search for an alternate candidate relay UE device by sending discovery announcements using the discovery resource designated by the first cell. In some cases, the remote UE device reports, to the second cell gNB, the first cell designated discovery resource to facilitate with resource coordination.

Although the techniques discussed herein may be applied to various types of systems and communication specifications, the devices of the example operate in accordance with at least one revision of a 3GPP New Radio (NR) V2X communication specification. The techniques discussed herein, therefore, may be adopted by one or more future revisions of communication specifications although the techniques may be applied to other communication specifications where sidelink or D2D is employed. More specifically the techniques may be applied to current and future releases of 3GPP NR specifications. For example, the techniques may also be applied to 3GPP NR (Rel-17).

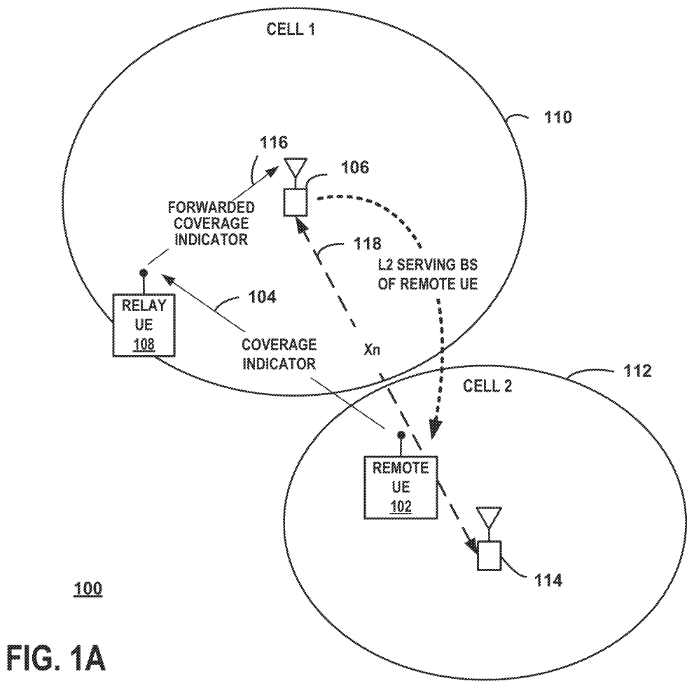

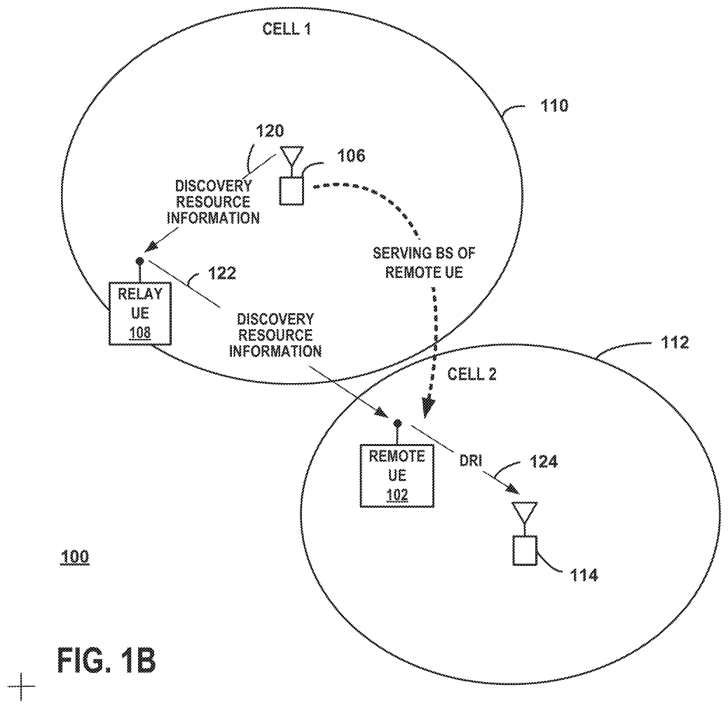

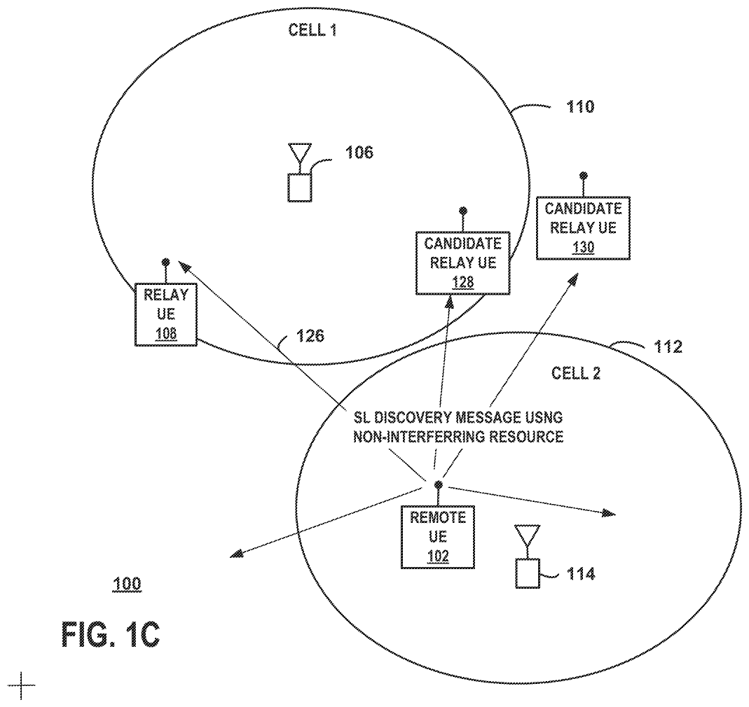

FIG. 1A is a block diagram of communication system 100 for an example where a remote UE device 102 transmits a cell coverage indicator 104 to a serving base station 106 through via relay UE device 108. For the example, the serving base station is a first base station 106, such a gNB, providing a first cell 110 and the remote UE device 102 is located within coverage of a second cell 112. Although the two cells may be provided by the same gNB in some situations, the second cell 112 is provided by a second base station 114, such as another gNB.

The example begins with the remote UE device 102 within coverage of the second cell 112 while being served by the base station 106 providing the first cell through the relay UE device 108 performing L2 relaying functions. The remote UE device 102 may have previously been out-of-coverage (OoC) while communicating with the first cell 110 through the relay UE device 108 and then migrated into the second cell 112. In other situations, the remote UE device 102 may have been in coverage of the second cell 112 before establishing L2 relay communication with the first cell 110 through the relay UE device 108. With either situation, the remote UE device 102 determines that it is within coverage of the second cell 112. For the examples herein, the remote UE device 102 is determined to be in-coverage of a cell when it is camped on the cell where the remote UE device 102 is in the RRC IDLE state or the RRC INACTIVE state with the cell, without connecting indirectly via a relay UE device. The remote UE device 102, therefore, determines that it is in coverage of the second cell 112 if it is camped on the second cell 112. In response, the remote UE device 102 sends the cell coverage indicator 104 to the relay UE device 108. In one example, the cell coverage indicator 104 is transmitted in a PC5-RRC message. In another example, the remote UE device sends the coverage indicator 104 in a PC5 broadcast message, such as a sidelink discovery signal. The coverage indicator 104 may be part of the MAC header, part of the upper layer message or may be a field within the physical sidelink control channel (PSCCH). The coverage indicator 104 indicates that the remote UE device 102 is within coverage of the second cell 112. In the example, therefore, the coverage indicator 104 at least identifies the second cell 112 with a unique identifier, such as cell ID. As discussed below in further detail, the coverage indicator 104 may include other information in some circumstances.

After receiving the coverage indicator 104, the relay UE device 108 forwards the coverage indicator, or sends a message indicative of the information provided in the coverage indicator 104, to the first gNB 106 indicating that the remote UE device 102 is within coverage of the second cell 112. In one example, the relay UE device 108 sends the coverage indicator of the remote UE device within the SidelinkUEInformation message, an RRC message. In response, the first cell 110 (gNB 106) may decide to configure the remote UE device 102 with suitable discovery resources, in a RRC Reconfiguration Message, that do not interfere with communication in the second cell 112. The RRC Reconfiguration Message for the remote UE device 102 is transparently delivered to the remote UE device via the relay UE device 108.

FIG. 1B is a block diagram of the system 100 for an example where the relay UE device 108 sends discovery resource information 120 to the remote UE device 102. In response to the forwarded coverage information 116 regarding the remote UE device 102, the first base station (gNB) 106, provides the remote UE device 102, via the relay UE device 108, with discovery resources that will at least minimize the potential for interference in the second cell 112. In one example, the first gNB 106 communicates with the second gNB 114 over a Xn interface to coordinate which discovery resources should be used by the remote UE device 102 while in coverage of the second cell 112. For example, the first cell 106 may send a Resource Status Request message over Xn to determine the load on the second cell 112. Based on the received Resource Status Response message, the first cell 110 may determine the appropriate discovery resource that may be used by the remote UE device 102. Other Xn messages may be used whereby the first cell may ask the second cell whether the first cell's current configured discovery resource for the remote UE device or pre-configured discovery resource would be in conflict with the second cell. In another example, the first gNB 106 is aware of the frequencies and resources used by the second gNB 114 providing the second cell 112.

The discovery resource information 120 at least indicates sidelink (SL) discovery resources for transmission of SL discovery messages that will not result in interference in second cell. For the example, the discovery resource information 120 is provided by the first base station 106 to the relay UE device 108 for forwarding to the remote UE device 102. As discussed above, the resources may be identified by the first base station 106 by coordinating with the second base station 114. In one example, the remote UE device 102 indicates to the first cell (via the relay UE device) the operating frequency of the second cell. In response, the first cell configures the discovery resource on a frequency different from the second cell. In another example, an indicator in SIB informs all UE devices whether preconfigured discovery resources may be used while in coverage. If so, the remote UE device 102 forwards this information to the first cell 110 allowing the first cell 110 to determine that the preconfigured discovery resource can be used. The relay UE device 108 forwards the SL discovery resource information in a discovery resource information SL communication 122 to the remote UE device 102. For the dedicated configuration in the example, the information is sent over the RRC Configuration Msg, with sl-DiscTxPoolSelected included in the RRC Configuration Msg. The sl-DiscTxPoolSelected reuses the sl-TxPoolScheduling which indicates the resources by which the UE device is allowed to transmit NR sidelink communication based on network scheduling on the configured bandwidth part (BWP). In some situations, the remote UE device 102 may inform the second base station (gNB) 114 of the discovery resource information.

The remote UE device may send a discovery resource information message 124 to the second base station 114 that identifies the SL discovery resources that were identified by the first cell and provided by the relay UE device 108 for transmission of SL discovery messages from the remote UE device 102 while the remote UE device 102 is in coverage of the second cell 112. In one example, the second cell 112 is notified of the discovery resource information 122 in order for the second cell 112 to initiate coordination with the first cell 110. In conventional systems, the remote UE device 102 is not be in an RRC_CONNECTED state with the second cell when the relay UE device facilitates connection to the first cell. In such situations, a Physical Random Access Channel (PRACH) procedure is invoked to provide the information to the second cell. The remote UE device 102 sends a short message, in Msg 3, to the second cell 112 without establishing an RRC connection with the second cell 112. As a result, the RRC connection is maintained with the first cell 110 and data continues through the first cell 110 (and relay UE device) while the second cell 112 is notified of the discovery resources assigned by the first cell 110.

In another example, the remote UE device 102 maintains an RRC connection with the first cell 110 through the relay UE device 108 while also maintaining a second RRC connection with the second cell 110. In at least some revisions of the 3GPP specification currently being considered, the remote UE device 102 is allowed to have multiple communication paths towards the network where one path may be via the relay UE device to first cell and the other path is the direct path to second cell. Such a technique may provide additional robustness and/or support higher data capacity. Where the remote UE device 102 is engaged in such a scenario, the remote UE device 102 reports the discovery resource information 124 to the second cell 112 through the RRC connection. In some situations, the remote UE device 102 provides the second cell 112 with information indicating that it is connected to the first cell 110 through the relay UE device 108 and the second cell 112 provides the discovery resources directly to the remote UE device 102 that are appropriate for avoiding inter-cell interference in the second cell 112. The first cell 110 continues to provide resources for the relay UE device 108.

FIG. 1C is a block diagram of the system 100 for an example where the remote UE device 102 sends a SL discovery message 126 using discovery transmission resources that will not interfere with communication in the second cell 112. For the example of FIG. 1C, the PC5 connection from the remote UE device 102 to the relay UE device 108 is lost after the events described with reference to FIG. 1A and FIG. 1B. In some cases, the Uu or PC5 link may experience Radio Link Failure (RLF) or the RSRP threshold falls below a threshold, for example. For the example, the relay UE device informs the remote UE device of Uu RLF. As a result, the remote UE device 102 determines that the connection to the network should be re-established either through the relay UE device 108 or through another candidate relay UE device. For the example, the remote UE device is still in RRC-CONN with the first cell and will transition to RRC IDLE if the re-establishment attempt fails. The remote UE device 102 transmits discovery messages using the non-interfering SL discovery resources assigned by the first cell to conduct a search for a candidate relay UE device. Alternate candidate relay UE devices 128, 130, as well as the relay UE device 108 may be evaluated as a candidate relay UE device. Due to the resource management by the relay UE device 108, the first gNB 106 and/or the second gNB 114, the SL discovery message 126 results in little, if any, interference to communication in the second cell 112. If the re-establishment attempt fails because no relay UE device can be found, the remote UE device 102 is no longer in the RRC CONNECTED state with the first cell and discovery resources assigned by the second cell are used for any SL discovery messages.

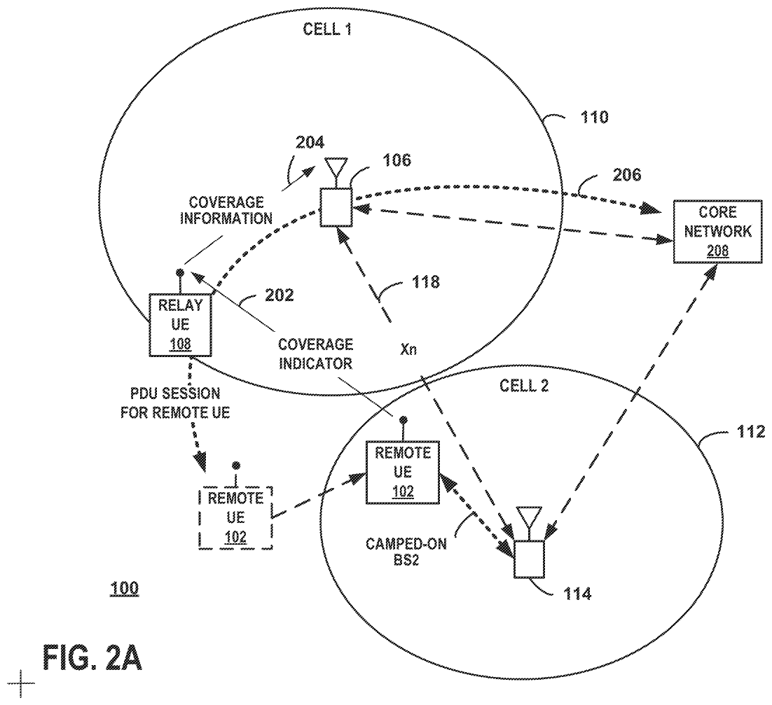

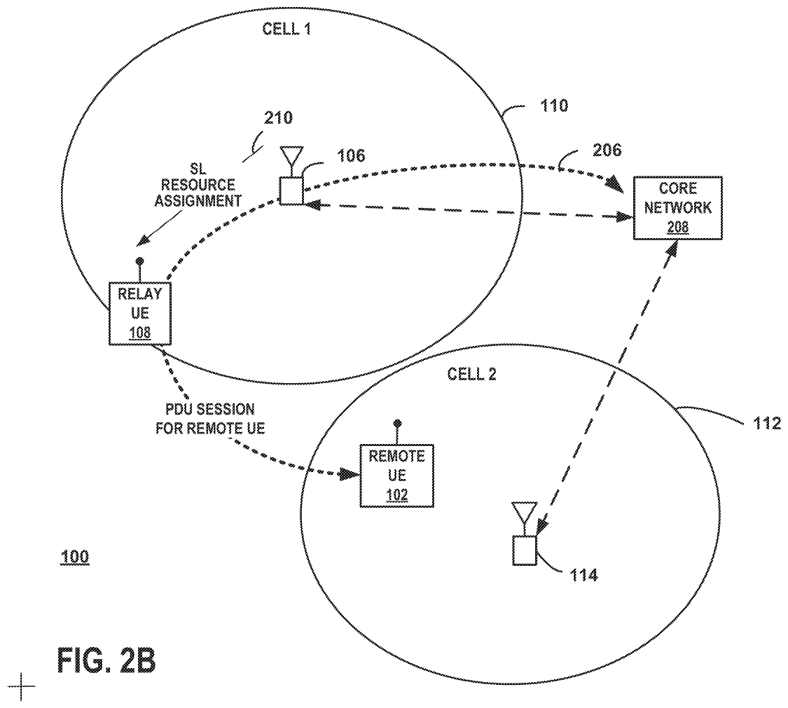

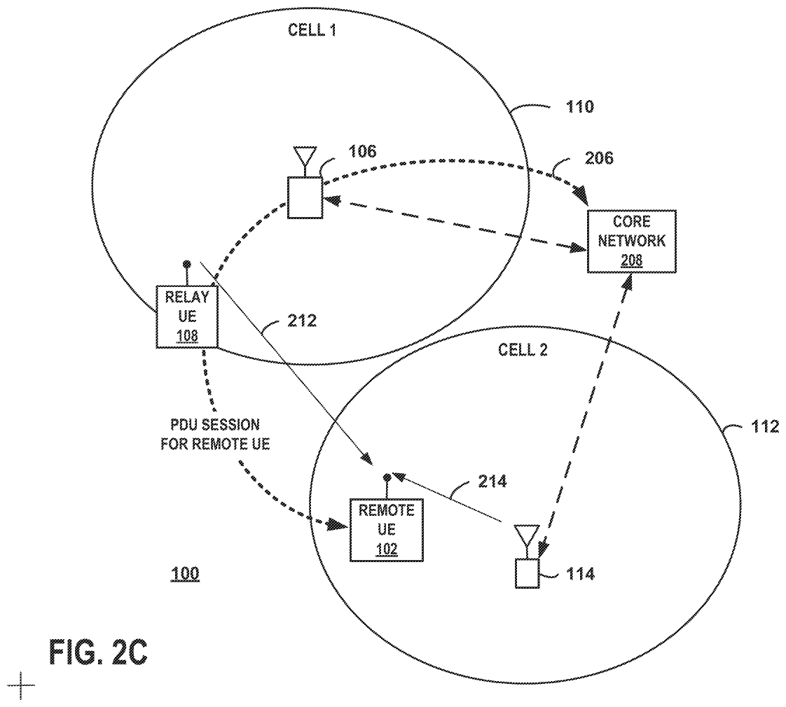

FIG. 2A is a block diagram of the communication system 100 for an example where a remote UE device 102 transmits a cell coverage indicator 202 to a relay UE device 108 providing L3 relaying and the relay UE device 108 sends coverage information 204 to its serving base station 106. For the example, the first base station 106 provides a network connection for the remote UE device 102 via L3 relaying. In accordance with 5G techniques, a Protocol Data Unit (PDU) session 206 with the core network 208 is established through the relay UE device 108 and the first cell 110. For the example of FIG. 2A, the remote UE device is connected to the network 208 through the relay UE device 108 and the first cell 110 when the remote UE device 102 is OoC. The remote UE device 102 sends a broadcast PC5-S message (application msg, i.e., “Direct Communication Request Msg”) to the selected relay UE device 108 to establish the PC5-RRC connection. In accordance with known techniques, the PDU session 206 is established.

The remote UE device 102 then moves into coverage of the second cell 112. In some situations, the remote UE 102 may transition to the RRC CONNECTED to the second cell 112 (gNB 114). In other situations, the remote UE device 102 may be in-coverage of the second cell 112 without being in RRC CONNECTED to the second cell 112. In such situations, the remote UE device 102 may determine it is within coverage of the second cell 112 based on MIB/SIBs received from the second cell 112. The remote UE device 102, therefore, is camped on the second cell 112 and the relay UE device 108 is camped on the first cell 110. As discussed above, for L2 relaying, the remote UE device 102 is controlled by the first gNB 106 which provides the first cell 110 where the relay UE device 108 is camped on. As compared to the examples above for L2 relaying, therefore, the remote UE device 102 is controlled by the second gNB 114 for L3 relaying rather than by the first gNB 106. With L3 relaying, the remote UE device 102 receives SIB updates from the second cell 112 that include SL discovery resource configurations. In accordance with known techniques, for example, the remote UE device 102 receives the discovery configuration from the second cell 112 via SIB12. For the examples of FIG. 2A, therefore, the relay UE device 108 may transmit sidelink signals with SL resources configured by the first cell 110 while the remote UE device 102 may transmit SL signals using the SL resources configured by the second cell 112.

Continuing with the example of FIG. 2A, the remote UE device 102 maintains the connection to the network 208 through the relay UE device 108 camped on the first cell 110 for the indirect connection (PDU session) to the network 208 after entering the second cell 112. For the example, the remote UE device 102 determines that the L3 relay connection is a more reliable connection to the network 208 than a direct connection to the second gNB 114 to the network 208. The determination may be based on a comparison of the SL-RSRP and Uu RSRP.

In response to entering the coverage area of the second cell 112, the remote UE device 102 sends a coverage indicator 202 to the relay UE device 108 where the coverage indicator 202 includes at least information that notifies the relay UE device that the remote UE device 102 is in-coverage and that identifies the frequency being used for sidelink communication as well as the operating frequency over the Uu link in the cell on which it is camped. In some situations, the coverage indicator 202 may include a cell identifier of the cell on which it is camped in addition to, or in the alternative to, the frequency. For the L3 examples herein, the coverage indicator 202 also includes a bandwidth combination capability indicator that indicates what combinations of communication bandwidths can be processed by the remote UE device 102. For the example of FIG. 2A, therefore, the remote UE device 102 sends a coverage indicator 202 that indicates the remote UE device is in coverage, the cell ID of the second cell, the frequency used by the second cell 112, and a bandwidth combination capability indicator. Although for example the coverage indicator 202 is a single message that is either broadcast or sent using PC5-RRC signaling, information may be sent multiple transmissions in some situations.

The relay UE device 108 forwards the information in the coverage indicator 202 to the first gNB 106 in a coverage information message 204. In one example, the relay UE device sends the coverage information of the remote UE device within the SidelinkUEInformation message, an RRC message. In some situations, the relay UE device 108 informs the first cell 110 of what types of resources will work for SL communication between the relay UE device 108 and the remote UE device 102. In such situations, the coverage information 204 may include a list of frequencies, for example. Therefore, the coverage indicator 202 may be forwarded information or information based on the information in the coverage indicator 202. Generally, the coverage information 204 is information that identifies, either directly or indirectly, the SL resources that can be used by the remote UE device 102 to receive SL signals from the relay UE device 108.

FIG. 2B is a block diagram of the system 100 for an example where the first gNB 106 sends SL resource information 210 to the relay UE device 108 providing L3 relaying for the remote UE device 102. After the first gNB 106 receives the forwarded coverage indicator 204 (or a request for SL resources from the relay UE device), the first gNB 106 sends the sidelink resource information 210 to configure the relay UE device 108 to use SL resources that are compatible with the remote UE device 102 receiving capability. In response to the information received at the first cell 110, the first cell 110 may decide to configure the relay UE device 108 with suitable resources in a RRC Reconfiguration Message that allows the remote UE device 102 to receive the SL transmissions from the relay UE device 108 while still receiving signals from the second cell 112. As a result, the information provided by the relay UE device 108 to the first cell 110 results in assignment of SL resources to the relay UE device 108 that allows the remote UE device 102 to receive signals from both the relay UE device 108 and the second cell 112.

FIG. 2C is a block diagram of the system 100 for an example where the remote UE device 102 receives signals from the second cell 112 and receives SL signals from the relay UE device 108 for a network connection 206 through the first cell 110 with L3 layering. The relay UE device 108 sends a SL signal 212 to forward information received from the first cell 110 for the PDU session 206 to the remote UE device 102 using the SL resources assigned by the first cell 110. The SL resources are selected in accordance with the bandwidth combination capability of the remote UE device 102. For the examples, the remote UE device 102 monitors the preferred resources for SL communication where the preferred resources may include one or more of 1) the SL frequency used to transmit the coverage indicator 202, 2) SL frequencies identified in the coverage indicator 202, 3) the SL discovery pool identified in the coverage indicator 202, and 4) the cell ID of the second cell 112. The remote UE device 102 receives the SL signals to maintain the PDU session 206 with the network 208 through the relay UE device 108 and the first cell 110. As a result, the remote UE device 102 can efficiently receive the SL signals 212 and the signals 214 from the second cell 112 while in coverage of the second cell 112.

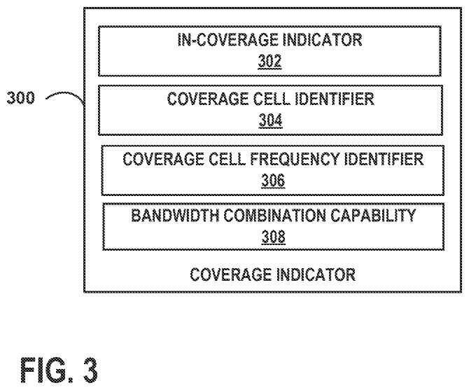

FIG. 3 is a block diagram of an example of a coverage indicator 300. Accordingly, the coverage indicator 300 is an example of the coverage indicator 104 for L2 relaying and the coverage indicator 202 for L3 relaying discussed above. The coverage indicator 300 may be part of the MAC header, part of the upper layer message, or may be a field within the physical sidelink control channel (PSCCH) in transmissions from the remote UE device. The coverage indicator 300 at least includes an in-coverage indicator 302 that indicates that the remote UE device is in-coverage of a cell. For the examples, the coverage indicator 300 also includes a coverage cell identifier 304 that identifies the cell on which the remote UE device is camped. A coverage cell frequency identifier 306 identifies the frequency channel(s) used in the cell. The coverage cell frequency identifier 306 may be omitted in some circumstances. The coverage cell frequency identifier 306, for example, may be omitted where the relay UE device is providing L2 relying. In some situations, the cell coverage identifier may be omitted where the coverage cell frequency identifier is included. The bandwidth combination capability 308 indicates the bandwidth combination capability of the remote UE device and, for the example, indicates which combination of bandwidths the remote UE device 102 is capable of supporting. The bandwidth combination capability 308 is optional for L2 relaying situations.

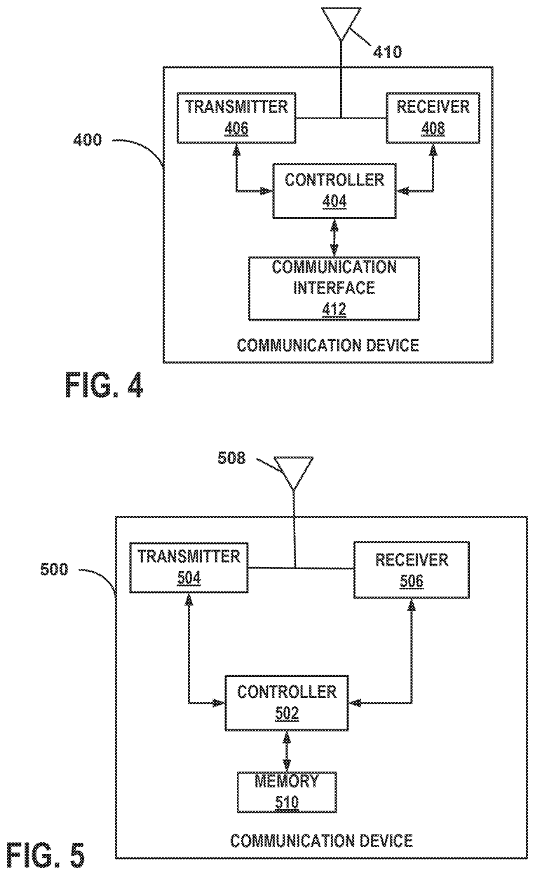

FIG. 4 is a block diagram of an example of a base station 400 suitable for use as both the base stations 106, 114 and any base station providing a cell or otherwise serving any of the UE devices. The base station 400 includes a controller 404, transmitter 406, and receiver 408, as well as other electronics, hardware, and code. The base station 400 is any fixed, mobile, or portable equipment that performs the functions described herein. The various functions and operations of the blocks described with reference to the base stations 106, 114, 400 may be implemented in any number of devices, circuits, or elements. Two or more of the functional blocks may be integrated in a single device, and the functions described as performed in any single device may be implemented over several devices. The base station 400 may be a fixed device or apparatus that is installed at a particular location at the time of system deployment. Examples of such equipment include fixed base stations or fixed transceiver stations. Although the base station may be referred to by different terms, the base station is typically referred to as a gNodeB or gNB when operating in accordance with one or more communication specifications of the 3GPP V2X operation. In some situations, the base station 400 may be mobile equipment that is temporarily installed at a particular location. Some examples of such equipment include mobile transceiver stations that may include power generating equipment such as electric generators, solar panels, and/or batteries. Larger and heavier versions of such equipment may be transported by trailer. In still other situations, the base station 400 may be a portable device that is not fixed to any particular location.

The controller 404 includes any combination of hardware, software, and/or firmware for executing the functions described herein as well as facilitating the overall functionality of the base station 400. An example of a suitable controller 404 includes code running on a microprocessor or processor arrangement connected to memory. The transmitter 406 includes electronics configured to transmit wireless signals. In some situations, the transmitter 406 may include multiple transmitters. The receiver 408 includes electronics configured to receive wireless signals. In some situations, the receiver 408 may include multiple receivers. The receiver 408 and transmitter 406 receive and transmit signals, respectively, through an antenna 410. The antenna 410 may include separate transmit and receive antennas. In some circumstances, the antenna 410 may include multiple transmit and receive antennas.

The transmitter 406 and receiver 408 in the example of FIG. 4 perform radio frequency (RF) processing including modulation and demodulation. The receiver 408, therefore, may include components such as low noise amplifiers (LNAs) and filters. The transmitter 406 may include filters and amplifiers. Other components may include isolators, matching circuits, and other RF components. These components in combination or cooperation with other components perform the base station functions. The required components may depend on the particular functionality required by the base station.

The transmitter 406 includes a modulator (not shown), and the receiver 408 includes a demodulator (not shown). The modulator modulates the signals to be transmitted as part of the downlink signals and can apply any one of a plurality of modulation orders. The demodulator demodulates any uplink signals received at the base station 400 in accordance with one of a plurality of modulation orders.

The base station 400 includes a communication interface 412 for transmitting and receiving messages with other base stations. The communication interface 412 may be connected to a backhaul or network enabling communication with other base stations. In some situations, the link between base stations may include at least some wireless portions. The communication interface 412, therefore, may include wireless communication functionality and may utilize some of the components of the transmitter 406 and/or receiver 408.

FIG. 5 is a block diagram of an example of a UE device 500 suitable for use as each of the UE devices 102, 108. In some examples, the UE device 500 is any wireless communication device such as a mobile phone, a transceiver modem, a personal digital assistant (PDA), a tablet, or a smartphone. In other examples, the UE device 500 is a machine type communication (MTC) communication device or Internet-of-Things (IOT) device. The UE device 500, therefore is any fixed, mobile, or portable equipment that performs the functions described herein. The various functions and operations of the blocks described with reference to UE device 500 may be implemented in any number of devices, circuits, or elements. Two or more of the functional blocks may be integrated in a single device, and the functions described as performed in any single device may be implemented over several devices.

The UE device 500 includes at least a controller 502, a transmitter 504 and a receiver 506. The controller 502 includes any combination of hardware, software, and/or firmware for executing the functions described herein as well as facilitating the overall functionality of a communication device. An example of a suitable controller 502 includes code running on a microprocessor or processor arrangement connected to memory. The transmitter 504 includes electronics configured to transmit wireless signals. In some situations, the transmitter 504 may include multiple transmitters. The receiver 506 includes electronics configured to receive wireless signals. In some situations, the receiver 506 may include multiple receivers. The receiver 504 and transmitter 506 receive and transmit signals, respectively, through antenna 508. The antenna 508 may include separate transmit and receive antennas. In some circumstances, the antenna 508 may include multiple transmit and receive antennas.

The transmitter 504 and receiver 506 in the example of FIG. 5 perform radio frequency (RF) processing including modulation and demodulation. The receiver 504, therefore, may include components such as low noise amplifiers (LNAs) and filters. The transmitter 506 may include filters and amplifiers. Other components may include isolators, matching circuits, and other RF components. These components in combination or cooperation with other components perform the communication device functions. The required components may depend on the particular functionality required by the communication device.

The transmitter 506 includes a modulator (not shown), and the receiver 504 includes a demodulator (not shown). The modulator can apply any one of a plurality of modulation orders to modulate the signals to be transmitted as part of the uplink signals. The demodulator demodulates the downlink signals in accordance with one of a plurality of modulation orders.

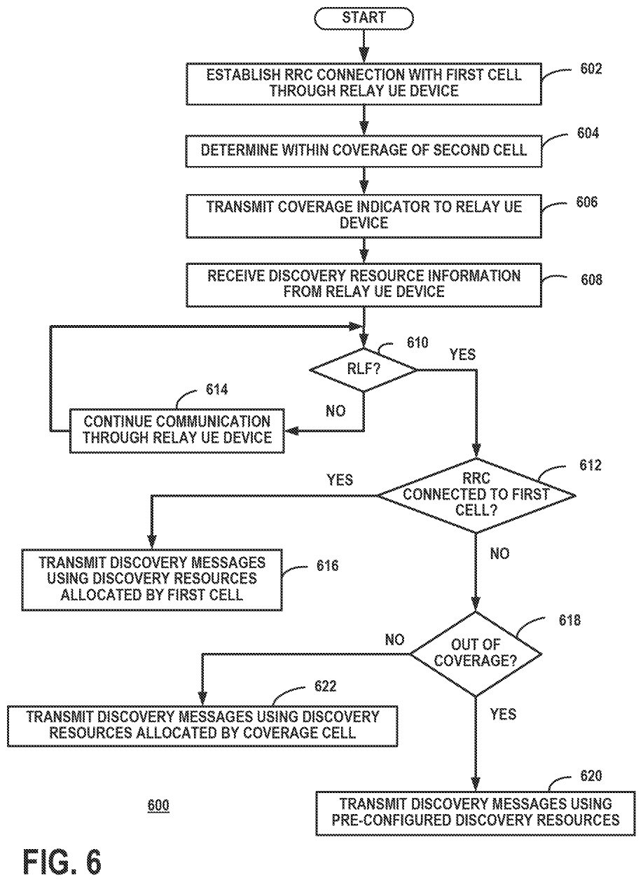

FIG. 6 is a flow chart of an example of a method 600 of sending a coverage indicator 104 from a remote UE device 102. The method, therefore, may be performed by a UE device such as the remote UE device 102 discussed above.

At step 602, an RRC connection is established with a first cell 110 through a relay UE device 108. For the example of FIG. 6, the RRC connection is established in accordance with known techniques and may be performed when the remote UE device 102 is either in coverage of a second cell 112 or OoC of the second cell 112. After the RRC connection is established, the serving cell of the remote UE device 102 is the first cell 110.

At step 604, it is determined that the remote UE device 102 is in coverage of a second cell 112. The remote UE device 102 may have already been in coverage of the second cell 112 when the RCC connection with the first cell 110 was established or the remote UE device 102 may have moved such that it migrated into an area where it is in coverage of the second cell 112. For the examples herein, the remote UE device 102 is determined to be in-coverage of a cell when it is camped on the cell where the remote UE device is in the RRC IDLE state or the RRC INACTIVE state with the cell, without connecting indirectly via a relay UE device. The remote UE device 102, therefore, determines that it is in coverage of the second cell 112 if it is camped on the second cell 112. As discussed above, the remote UE device 102 may determine that the connection to the first cell 110 through the relay UE device 108 is preferred to an RRC connection to the second cell 112.

At step 606, a coverage indicator 104 is transmitted to the relay UE device 108. The remote UE device 102 may send the coverage indicator 104 in a PC5 broadcast message, such as a sidelink discovery signal, or the coverage indicator 104 may be part of the MAC header, part of the upper layer message, or may be a field within the physical sidelink control channel (PSCCH). The coverage indicator 104 indicates that the remote UE device 102 is within coverage of the second cell 112 an may provide additional information in some situations. In the example, therefore, the coverage indicator 104 at least identifies the second cell 112 with a unique identifier, such as cell ID.

At step 608, discovery resource information 122 is received from the relay UE device 108. The discovery resource information 122 identifies discovery resources that the remote UE device 102 can use for transmission of SL discovery signals where the discovery resources are assigned by the first cell 110. The first cell 110, therefore, provides SL discovery configuration for the remote UE device 102 over L2 relaying through the relay UE device 108.

At step 610, it is determined whether a radio link failure (RLF) has occurred. If either the PC5 link to the relay UE device 108 or the Uu link from the relay UE device 108 to the first cell 110 has experienced RLF, the remote UE device 102 determines RLF has occurred and proceeds to step 612. Otherwise, the method continues with communication at step 614 and returns to step 610.

At step 612, it is determined whether the remote UE device 102 remains RRC connected to the first cell 110. If the remote UE device 102 is still RRC connected to the first cell 110, the method proceeds to step 616 where the remote UE device 102 transmits discovery messages using the discovery resources identified by the discovery resource information. Accordingly, the remote UE device 102 can use the discovery resource configuration provided by the first cell 110 and identified in the discovery resource information 122 received from the relay UE device 108 if the remote UE device is still RRC connected. The remote UE device 102, therefore, searches for candidate relay UE devices using the discovery resource configuration provided by the first cell 110. The candidate relay devices may include the relay UE device 108 as well as other candidate relay UE devices 128, 130 which may be in coverage of the first cell 110.

If the remote UE device 102 is not RRC connected to the first cell 110, the method continues at step 618 where the remote UE device 102 determines if it is out of coverage (OoC). If the remote UE device 102 is not in coverage of any cell, the method proceeds to step 620 where the remote UE device 102 uses pre-configuration discovery resources for transmitting discovery messages. If the remote UE device is in coverage of a cell, the method proceeds to step 622 where the remote UE device 102 uses the discovery resource configuration provided by the serving cell which may be the second cell 112.

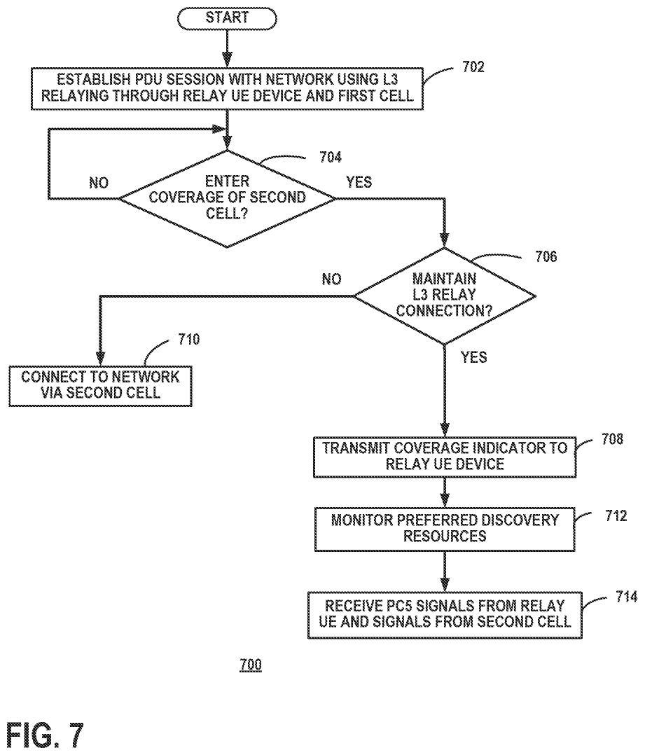

FIG. 7 is a flow chart of an example of a method 700 of sending a coverage indicator 202 from a remote UE device 102 where a relay UE device 108 is providing L3 relaying to a first cell 110. The method, therefore, may be performed by a UE device such as the remote UE device 102 discussed above.

At step 702, a PDU session 206 with the core network 208 is established through a relay UE device 108 and a first cell 110. For the example of FIG. 7, the remote UE device 102 is out of coverage when a PDU session 206 is established. The remote UE device 102 sends a broadcast PC5-S message, such as a “Direct Communication Request Msg”, to the relay UE device 108 to establish the PC5-RRC connection. The PDU session 206 is established in accordance with known techniques where the relay UE device 108 provides L3 relaying for the session.

At step 704, the remote UE device 102 determines whether it is in coverage of a second cell 112. In some situations, the remote UE 102 may determine it is in coverage of the second cell 112 when it transitions to the RRC CONNECTED to the second cell 112. In other situations, the remote UE device 102 may determine it is within coverage of the second cell 112 based on MIB/SIBs received from the second cell 112. The remote UE device 102 continues to monitor its coverage status at step 704 if is determined that it is currently out of coverage. If the remote UE device 102 is in coverage of the second cell, the method proceeds to step 706.

At step 706, it is determined whether the L3 relay connection (PDU session 206) should be maintained or if the remote UE device 102 should use the second cell 112 to connect to the network 208. For the example, the remote UE device 102 determines whether the L3 relay connection is a more reliable connection to the network 208 than a direct connection to the second gNB 114. The determination may be based on a comparison of the SL-RSRP and Uu RSRP. If the L3 relayed connection should be maintained, the method continues at step 708. Otherwise, the remote UE device 102 connects to the network 208 through the second cell at step 710.

At step 708, a coverage indicator 202 is transmitted to the relay UE device 108. For the example, the coverage indicator 202 includes at least information that notifies the relay UE device 108 that the remote UE device 102 is in-coverage and the frequency being used for sidelink communication as well as the operating frequency over the Uu link in the cell on which it is camped. In some situations, the coverage indicator 202 may include a cell identifier of the cell on which it is camped in addition to, or in the alternative to, the frequency. For the L3 relay examples herein, the coverage indicator 202 also includes a bandwidth combination capability indicator that indicates what combinations of communication bandwidths can be processed by the remote UE device 102. For the example of FIG. 7, therefore, the remote UE device 102 sends a coverage indicator 202 that indicates the remote UE device is in coverage, the cell ID of the second cell, the frequency used by the second cell 112, and a bandwidth combination capability indicator. Although for example the coverage indicator 202 is a single message that is either broadcast or sent using PC5-RRC signaling, information may be sent multiple transmissions in some situations.

At step 712, the remote UE device 102 monitors the preferred discovery resources. The preferred resources may include any combination of the SL frequency used to transmit the coverage indicator 202, SL frequencies identified in the coverage indicator 202, the SL discovery pool identified in the coverage indicator 202, and the cell ID of the second cell 112.

At step 714, the remote UE device 102 receives the PC5 signals from the relay UE device 212 for the PDU session established with L3 relaying. The remote UE device can also receive signals 214 from the second cell 112 since the second cell 112 is the serving cell.

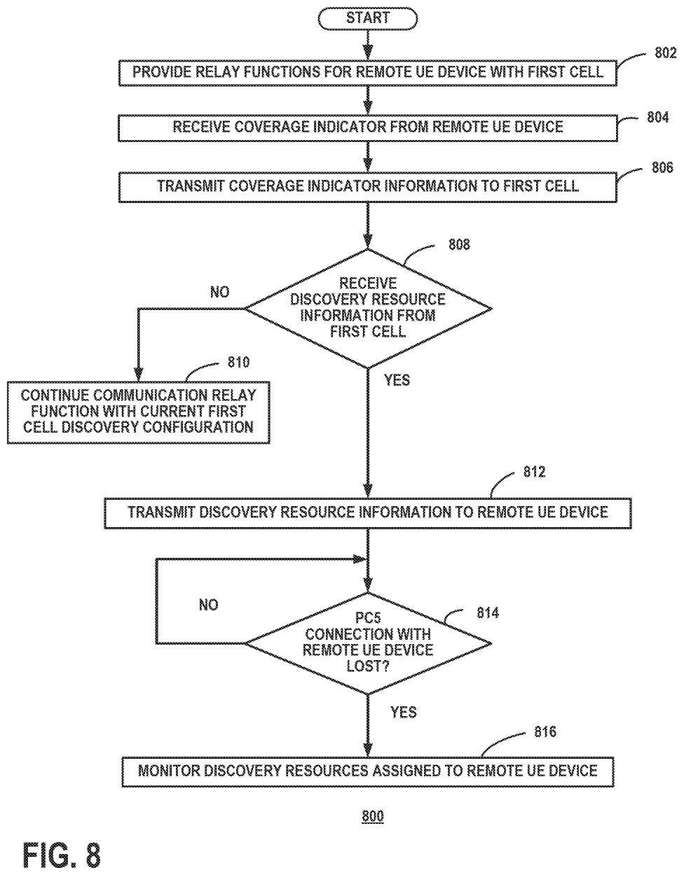

FIG. 8 is a flow chart of an example of a method 800 of managing discovery resources after receiving a coverage indicator 104 from a remote UE device 102. The method, therefore, may be performed by a UE device such as the relay UE device 108 discussed above.

At step 802, the relay UE device 108 provides relay functions for a remote UE device 102 to facilitate a L2 relay connection between the remote UE device 102 and a first cell 110. The remote UE device is RRC connected to the first cell 110. For the example of FIG. 8, the RRC connection is established in accordance with known techniques and may be performed when the remote UE device 102 is either in coverage of a second cell 112 or OoC. After the RRC connection is established, the serving cell of the remote UE device 102 is the first cell 112.

At step 804, a coverage indicator 104 is received from the remote UE device 102. The remote UE device 102 may send the coverage indicator 104 in a PC5 broadcast message, such as a sidelink discovery signal, or the coverage indicator 104 may be part of the MAC header, part of the upper layer message, or may be a field within the physical sidelink control channel (PSCCH). The coverage indicator 104 indicates that the remote UE device 102 is within coverage of the second cell 112. In the example, the coverage indicator 104 at least identifies the second cell 112 with a unique identifier, such as cell ID.

At step 806, coverage indicator information 116 is transmitted to the first cell 110. The coverage indicator information 116 may be a forwarded version of the coverage indicator 104 received from the remote UE device 102 or may be information derived form, or extracted from, the coverage indicator 104.

At step 808, it is determined whether discovery resource information 120 has been received from the first cell 110. In one example, the first cell 110 transmits a response to the relay UE device 108 either identifying the discovery resources that can be used by the remote UE or indicating that no additional resources have been identified. In other situations, the first cell 110 only provides the discovery resource information if discovery resources are available and have been identified for use by the remote UE device 102. If a no discovery resource information for the remote UE device is received at the relay UE device 108, the method continues at step 810. If discovery resource information has been received from the first cell 110, the method proceeds to step 812.

At step 810, the relay UE device continues using the discovery configuration provided by the first cell 110. In some situations, the relay UE device 108 may provide a message to the remote UE device 102 that no discovery resources have been identified by the first cell 110. In one example, the relay UE device does not evaluate messages received from the first cell that are destined for the remote UE device 102 and transparently forwards the communications through the L2 relay link. Accordingly, step 808 may be omitted in some situations.

At step 812, the discovery resource information is transmitted to the remote UE device 102. In some situations, the relay UE device 108 transparently forwards communication signals from the first cell 110 to the remote UE device 102 by providing the L2 relay link. In other situations, the relay UE device 108 may generate a discovery resource information message based on discovery resource information received from the first cell for transmission to the remote UE device. The discovery resource information 122 identifies SL resources that the remote UE device 102 can use for transmission of SL discovery signals.

At step 814, it is determined whether the PC5 link to the remote UE device 102 has been lost. If the relay UE device remains connected to the remote UE device 102 through the sidelink, the method returns to step 814 where the relay UE device continues to monitor the status of the PC5 link. If the PC5 link has failed, the relay UE device monitors discovery resources identified in the discovery resource information 120, 122 at step 816. Such a technique allows the relay UE device 108 to re-establish the PC5 connection before the remote UE device 102 is no longer RRC CONNECTED to the first cell 110.

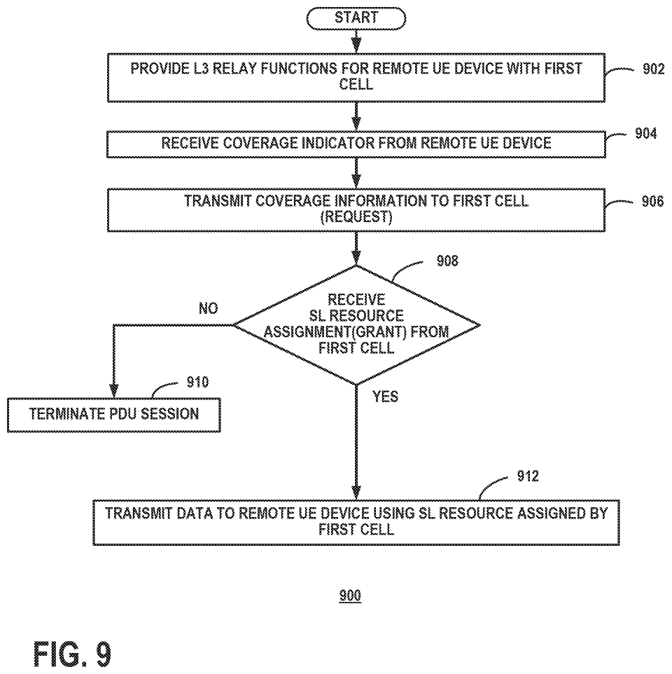

FIG. 9 is a flow chart of an example of a method 900 of managing discovery resources after receiving a coverage indicator 202 from a remote UE device 102 when providing L3 layering service. The method, therefore, may be performed by a UE device such as the relay UE device 108 discussed above.

At step 902, the relay UE device 108 provides relay functions for a remote UE device 102 to facilitate a L3 relay connection between the remote UE device 102 and a first cell 110. The relay UE device facilitates a PDU session 206 for the remote UE device 102 with the core network 208. For the example of FIG. 9, the PDU session 206 is established in accordance with known techniques when the remote UE device 102 is OoC.

At step 904, a coverage indicator 202 is received from the remote UE device 102. The remote UE device 102 may send the coverage indicator 104 in a PC5 broadcast message, such as a sidelink discovery signal, or the coverage indicator 104 may be part of the MAC header, part of the upper layer message, or may be a field within the physical sidelink control channel (PSCCH). The coverage indicator 202 indicates that the remote UE device 102 is within coverage of the second cell 112 and may provide other information regarding the second cell and/or the remote UE device. For the example of FIG. 9, the coverage indicator identifies the second cell 112 with a unique identifier such as cell ID, provides a second cell frequency identifier, and provides a bandwidth combination capability of the remote UE device.

At step 906, coverage information 204 is transmitted to the first cell 110. For the example, the coverage information 204 is a request by the relay UE device 108 for SL resources for transmission of SL signals to the remote UE device 102. In one example, the coverage information 204 includes information contained in, or derived from, the coverage indicator 202 that allows the base station 106 to determine SL resources that can be used by the relay UE device for transmission of SL signals to the remote UE device and that can be received by the remote UE device. The bandwidth combination capability of the remote UE device, for example, may be used to select resources that can be monitored by the remote UE device while monitoring resources in the second cell. In other examples, the relay UE device determines the preferred resources for SL transmission and the coverage information 204 identifies the selected preferred resources that ae being requested from the first cell 110. In some situations, for example, the relay UE device can select resources that the remote UE device prefers from resources already authorized by the gNB.

At step 908, it is determined whether a SL resource assignment 210 has been received from the first cell. In some situations, the SL resource assignment 210 is a grant to use the requested resources that were requested by the relay UE device 108 in the coverage information message 204. In other situations, the SL resource assignment 210 identifies the SL resources that are authorized for SL transmission to the remote UE device. If no SL resources are assigned or if the first cell 110 does not grant the use of additional SL resources, the method proceeds to step 910. Otherwise, the method continues at step 912.

At step 910, the PDU session is terminated. If no SL resources are granted, the gNB is not allowing SL operation and the relaying operation should be terminated. The gNB releases the remote UE device to IDLE/INACTIVE and the PC5 connection is released by either the relay UE device or the remote UE device.

At step 912, the relay UE device transmits data to the remote UE device using the resources granted or assigned by the first cell.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A remote user equipment (UE) device comprising:
a controller configured to determine that the remote UE device is connected to a network through a first cell and a relay UE device and to determine that the remote UE device is in-coverage of a second cell; and
a transmitter configured to send a cell coverage indicator to the first cell via the relay UE device, the cell coverage indicator indicating to the first cell that the remote UE device is in-coverage of the second cell.

2. The remote UE device of claim 1, where the first cell is the serving cell of the remote UE device and the remote UE device is in a Radio Resource Control (RRC) connected (RRC-CONNECTED) state with the first cell.

3. The remote UE device of claim 2, further comprising:
a receiver configured to receive, via the relay UE device, discovery information from the first cell, the discovery information indicating discovery signal resources.

4. The remote UE device of claim 3, wherein the discovery signal resources are allocated for transmission of sidelink discovery signals from the remote UE device.

5. The remote UE device of claim 4, wherein the transmitter is configured to transmit the discovery information to the second cell.

6. The remote UE device of claim 3, wherein the discovery signal resources are allocated for transmission of sidelink discovery signals from the relay UE device.

7. The remote UE device of claim 1, wherein the transmitter is configured to send the cell coverage indicator to the relay UE device via a PC5-RRC message.

8. The remote UE device of claim 1, wherein the transmitter is configured to send the cell coverage indicator to the relay UE device via a PC5 broadcast message.

9. The remote UE device of claim 2, wherein the controller is configured to determine when a PC5 connection to the relay UE device forming a portion of the communication path to the first cell has become inoperable, the transmitter configured to transmit a sidelink discovery signal using the discovery signal resources.

10. The remote UE device of claim 1, wherein the coverage indicator comprises at least one of a coverage cell identifier identifying the second cell and a coverage cell frequency identifier indicative of a sidelink frequency used in the second cell.

11. The remote UE device of claim 1, wherein the second cell is the serving cell of the remote UE device and the remote UE device is connected to a core network over L3 relaying through the relay UE device and the first cell.

12. The remote UE device of claim 11, wherein the coverage indicator comprises a bandwidth combination capability indicator indicative of the bandwidth combination capability of the remote UE device.

13. The remote UE device of claim 11, further comprising a receiver configured to receive sidelink signals from the relay UE device over a sidelink communication resource and to receive Uu signals over a Uu communication resource from the second cell.

14. A relay user equipment (UE) device comprising:
a transceiver comprising a transmitter and a receiver; and
a controller configured to provide, with the transceiver, a relay connection between a remote UE device and a first cell,
the receiver configured to receive, from the remote UE device, a cell coverage indicator indicating that the remote UE device is in-coverage of the second cell,
the transmitter configured to transmit, to the first cell, coverage information based on the cell coverage indicator,
the receiver configured to receive, from the first cell, sidelink resource information.

15. The relay UE device of claim 14, wherein the sidelink resource information is discovery resource information indicating a sidelink resource for transmission, from the remote UE device, of discovery messages that result in minimal interference to communication in the second cell,
the transmitter configured to transmit the discovery resource information to the remote UE device.

16. The relay UE device of claim 15, where the first cell is the serving cell of the remote UE device and the remote UE device is in a Radio Resource Control (RRC) connected (RRC-CONNECTED) state with the first cell.

17. The relay UE device of claim 16, wherein the receiver is configured to receive the cell coverage indicator from the remote UE device via a PC5-RRC message.

18. The relay UE device of claim 16, wherein the receiver is configured to receive the cell coverage indicator from the remote UE device via a PC5 broadcast message.

19. The relay UE device of claim 16, wherein the controller is configured to determine when a PC5 connection to the relay UE device forming a portion of the communication path to the first cell has become inoperable, the receiver configured to receive a sidelink discovery signal using the discovery signal resources from the remote UE device.

20. The relay UE device of claim 16, wherein the coverage indicator comprises at least one of a coverage cell identifier identifying the second cell and a coverage cell frequency identifier indicative of a sidelink frequency used in the second cell.

21. The relay UE device of claim 14, wherein the second cell is the serving cell of the remote UE device and the controller is configured to connect the remote UE device to a core network over L3 relaying through the first cell, the sidelink resource information indicating a sidelink communication resource for transmission of signals to the remote UE device.

22. The relay UE device of claim 21, wherein the coverage indicator comprises a bandwidth combination capability indicator indicative of the bandwidth combination capability of the remote UE device.

23. The relay UE device of claim 21, the transmitter configured to transmit sidelink signals from the relay UE device over the sidelink communication resource that can be received by the remote UE device while in coverage of the second cell.
